(19) United States
(12) Patent Application Publication
(10) Pub. No.: US 2026/0195231 A1
(43) Pub. Date: Jul. 9, 2026

(54) PROCESSOR PERFORMANCE TUNING METHOD AND ELECTRONIC DEVICE USING THE SAME

(71) Applicant: Acer Incorporated, New Taipei City (TW)

(72) Inventors: Kai-Nung Su, New Taipei City (TW); Ruey-Ching Shyu, New Taipei City (TW)

(73) Assignee: Acer Incorporated, New Taipei City (TW)

(21) Appl. No.: 19/241,384

(22) Filed: Jun. 18, 2025

(30) Foreign Application Priority Data
Jan. 9, 2025 (TW) 114100926

(51) Int. Cl. G06F 11/34; G06N 20/00

(52) U.S. Cl. CPC G06F 11/3409; G06N 20/00

(57) ABSTRACT

A processor performance tuning method and an electronic device using the same are provided. The method may include the following steps. A training dataset is created. The training dataset may include a device design parameter, an actual performance test score, and an actual target design parameter of each of a plurality of tested electronic devices. A machine learning model is trained based on the training dataset. A device design parameter of an electronic device to be tested is received. By utilizing the trained machine learning model according to the device design parameter of the electronic device to be tested, a predicted target design parameter of the electronic device to be tested is predicted. An operation is performed according to the predicted target design parameter.

### CROSS-REFERENCE TO RELATED APPLICATION

This application claims the priority benefit of Taiwan application serial no. 114100926, filed on Jan. 9, 2025. The entirety of the above-mentioned patent application is hereby incorporated by reference herein and made a part of this specification.

### BACKGROUND

### Technical Field

The disclosure relates to processing performance analysis for computing device, and particularly to a processor performance tuning method and electronic devices using the method.

### Description of Related Art

In today's computing systems, processor performance is considered one of the core indicators for evaluating the overall performance of a computer system. From the perspective of computer system design, processor performance is closely related to factors such as hardware specifications, mechanical design, thermal modules, and circuit implementation. In the current technological landscape, effectively allocating and optimizing various device design parameters to achieve optimal processor performance under specific scenarios remains a complex and challenging task. The reason is that the system design of each computing device may include numerous interrelated factors, including hardware architecture, mechanical design, thermal solutions, and circuit implementation, all of which are tightly linked to real-world usage scenarios. At present, finding the optimal settings for device design parameters is not a simple task and often relies on past practical experience or repetitive and time-consuming testing. Traditionally, developers need to conduct numerous trials and performance tests under different setting conditions, which not only consumes a significant amount of time and resources but may also lead to uncertainties in the trial-and-error process.

### SUMMARY

In view of this, the disclosure presents an electronic device and a processor performance tuning method that may solve the aforementioned technical problems.

An exemplary embodiment of the disclosure provides a processor performance tuning method, which may include the following steps. A training dataset is created. The training dataset may include a device design parameter, an actual performance test score, and an actual target design parameter of each of a plurality of tested electronic devices. A machine learning model is trained based on the training dataset. A device design parameter of an electronic device to be tested is received. By utilizing the trained machine learning model according to the device design parameter of the electronic device to be tested, a predicted target design parameter of the electronic device to be tested is predicted. An operation is performed according to the predicted target design parameter.

An exemplary embodiment of the disclosure provides an electronic device, which may include a storage device and a processor. The processor is coupled to the storage device and configured to execute the following operations. A training dataset is created. The training dataset may include a device design parameter, an actual performance test score, and an actual target design parameter of each of a plurality of tested electronic devices. A machine learning model is trained based on the training dataset. A device design parameter of an electronic device to be tested is received. By utilizing the trained machine learning model according to the device design parameter of the electronic device to be tested, a predicted target design parameter of the electronic device to be tested is predicted. An operation is performed according to the predicted target design parameter.

Based on the above, in the embodiments of the disclosure, the training dataset including the device design parameter, the actual performance test score, and the actual target design parameter of the tested electronic devices may be configured to train a machine learning model. Subsequently, the trained machine learning model may predict a predicted target design parameter for an electronic device to be tested according to the device design parameter of the electronic device to be tested, to perform an operation based on the predicted target design parameter. As a result, a more efficient approach can be implemented to determine the optimal parameter configurations that enable the processor's performance to meet the design requirements, thereby shortening the product development and testing timeline.

### BRIEF DESCRIPTION OF THE DRAWINGS

FIG. 1 is a block diagram of an electronic device according to an embodiment of the disclosure.

FIG. 2 is a flowchart of a processor performance tuning method according to an embodiment of the disclosure.

FIG. 3 is a schematic diagram of an operation interface for tuning processor performance according to an embodiment of the disclosure.

FIG. 4 is a flowchart of a processor performance tuning method according to an embodiment of the disclosure.

FIG. 5 is a schematic diagram of a processor performance tuning method according to an embodiment of the disclosure.

FIG. 6 is a flowchart of a processor performance tuning method according to an embodiment of the disclosure.

FIG. 7 is a schematic diagram of a processor performance tuning method according to an embodiment of the disclosure.

### DESCRIPTION OF THE EMBODIMENTS

Some embodiments of the disclosure will be described in detail with reference to the accompanying drawings. In the following description, when the same component symbols appear in different drawings, they will be regarded as the same or similar components. These embodiments are only a part of the disclosure and do not reveal all possible implementations of the disclosure. More precisely, these embodiments are only examples of the methods and devices in the patent claims of the disclosure.

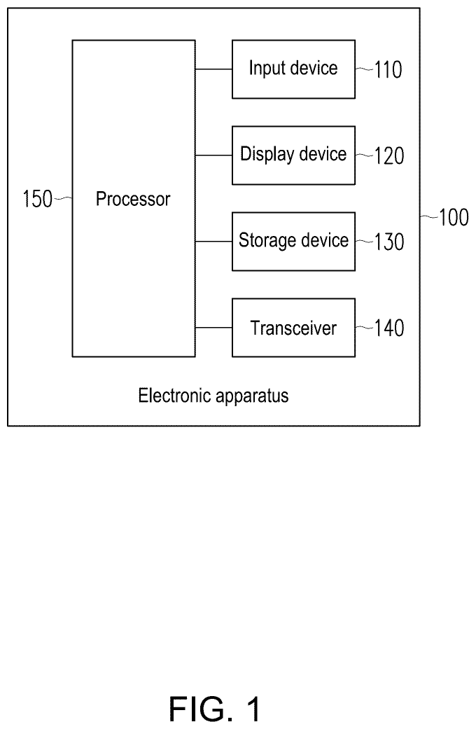

FIG. 1 is a block diagram of an electronic device according to an embodiment of the disclosure. Referring to FIG. 1, the electronic device 100 may include an input device 110, a display device 120, a storage device 130, a transceiver 140, and a processor 150. The electronic device 100 may be, for example, a tablet computer, a laptop computer, a desktop computer, an all-in-one computer, or a server, or other computing devices with computational capabilities. The disclosure does not limit the type of device.

The input device 110 is configured to receive user inputs from a user. The input device 110 may be, for example, a mouse, a keyboard, a touch input device, or a microphone, etc.

The display device 120 may be, for example, a Liquid Crystal Display (LCD), a Light-Emitting Diode (LED) display, an Organic Light-Emitting Diode (OLED) display, or other types of displays. The disclosure does not limit the type of display. In the embodiments of the disclosure, the display device 120 may be configured to display a user operation interface.

The storage device 130 is configured to temporarily or permanently store data, such as storing files, documents, images, instructions, codes, software modules (e.g., operating systems, applications, drivers), and other data. Specifically, the storage device 130 may include volatile storage circuits. The volatile storage circuits are configured to store data in a volatile manner. For example, the volatile storage circuits may include random access memory (RAM) or similar volatile storage media. In addition, the storage device 130 may also include non-volatile storage circuits. The non-volatile storage circuits are configured to store data in a non-volatile manner. For example, the non-volatile storage circuits may include read-only memory (ROM), solid-state drive (SSD), and/or traditional hard disk drive (HDD) or similar non-volatile storage media. The number of storage devices 130 may be one or more, and the disclosure does not limit this.

The transceiver 140 may transmit and receive signals wirelessly or via wired connections. The transceiver may also perform operations such as low-noise amplification, impedance matching, mixing, up or down frequency conversion, filtering, amplification, and similar operations. The electronic device 100 may receive and transmit data through the transceiver 140, such as transmitting and receiving data via the Internet. In some embodiments, the electronic device 100 may also include an antenna (not shown) for receiving wireless radio frequency signals.

The processor 150 is coupled to the input device 110, the display device 120, the storage device 130, and the transceiver 140, and may be a general-purpose processor, special-purpose processor, conventional processor, Central Processing Unit (CPU), Graphic Processing Unit (GPU), Vision Processing Unit (VPU), Neural network Processing Unit (NPU) and/or Tensor Processing Unit (TPU), digital signal processor, multiple microprocessors, one or more microprocessors combined with digital signal processor cores, controller, microcontroller, Application Specific Integrated Circuit (ASIC), Field Programmable Gate Array (FPGA), any other type of integrated circuit, state machine, Advanced RISC Machine (ARM)-based processor, and the like. The processor 150 may access and execute instructions or code stored in the storage device 130 to implement the processor performance tuning method in the embodiments of the disclosure.

In the embodiments of the disclosure, historical design data accumulated over the years can be utilized through machine learning to uncover the complex relationships between various design parameters and processor performance. This approach enables the efficient identification of design parameter configurations that ensure the processor's performance meets the required standards during the development of new devices, significantly reducing the time required for design and validation.

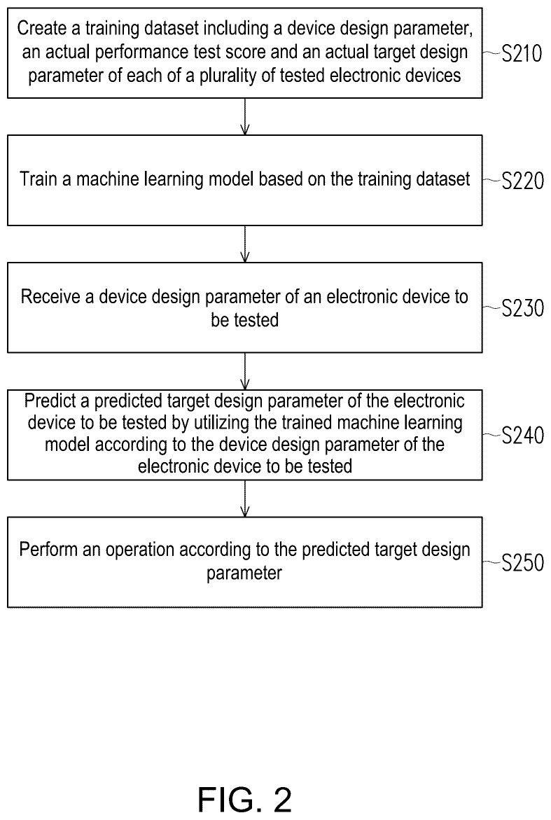

FIG. 2 is a flowchart of a processor performance tuning method according to an embodiment of the disclosure, and the method process of FIG. 2 may be implemented by various components of the electronic device 100 in FIG. 1. Referring to FIG. 1 and FIG. 2 simultaneously, the following provides a detailed explanation of the steps of the processor performance tuning method in a embodiment in conjunction with the various components of the electronic device 100 in FIG. 1.

At step S210, the processor 150 may create a training dataset. The training dataset may include a device design parameter, an actual performance test score, and an actual target design parameter of each of multiple tested electronic devices. Herein, each tested electronic device is a computing device including a processor, and each tested electronic device may execute a performance test procedure to obtain the actual performance test score of its processor. The processor of each tested electronic device may be a Central Processing Unit (CPU), Graphic Processing Unit (GPU), or Neural Network Unit (NPU), etc.

In various embodiments, all tested electronic devices may be the same type, such as notebooks, servers, desktop computers, all-in-one computers, or tablet computers, etc. Furthermore, in some embodiments, the multiple tested electronic devices may be multiple notebooks with different device specifications. In some embodiments, the multiple tested electronic devices may be multiple servers with different device specifications. In some embodiments, the multiple tested electronic devices may be multiple tablet computers with different device specifications, and so on.

Furthermore, the training dataset may include a plurality of feature variables and at least one target variable for training a machine learning model. The feature variables serve as the primary basis for the machine learning model during training. When training the machine learning model, the relationship between feature variables and target variable is the focus of model learning. In some embodiments, the processor 150 may use multiple device design parameters and actual performance test scores of the tested electronic devices as multiple feature variables, and use the actual target design parameters of the tested electronic devices as a target variable. Alternatively, in some embodiments, the processor 150 may use multiple device design parameters of the tested electronic devices as multiple feature variables, and use the actual target design parameters and actual performance test scores of the tested electronic devices as multiple target variables.

In some embodiments, the device design parameter may include at least one of a hardware specification parameter and a processor performance management parameter. The device design parameter may include design features, specification parameters, and configurable parameter settings of the electronic device, etc.

In some embodiments, the hardware specification parameter may include at least one of a processor specification parameter and a heat dissipation specification parameter. The processor specification parameter is the specification parameter of the processor, for example, cache memory capacity, number of performance cores (P-cores), number of efficiency cores (E-cores), number of threads, base clock frequency, boost clock frequency, Thermal Design Power (TDP), or processor manufacturing process (e.g., 10 nanometers), etc. The heat dissipation specification parameter is the specification parameter of the heat dissipation module, for example, fan size, fan rotation speed, number of heat pipes, heat sink size, or heat sink material, etc. In addition, the hardware specification parameter may also include motherboard material or number of motherboard layers, etc.

In some embodiments, the processor performance management parameter may include at least one of a power control parameter and a thermal management parameter. The processor performance management parameter involves controlling the power consumption and heat of the processor to ensure the system operates in a high-performance and stable state. The power control parameter may include Power Limit (PL) and Turbo Time Parameter (Tau), etc. The Power Limit (PL) may further include Power Limit 1 (PL 1), Power Limit 2 (PL 2), or Power Limit 3 (PL 3) for overclocking. The thermal management parameter may include a temperature limit parameter. The aforementioned temperature limit parameter may be, for example, the Thermal Control Circuit (TCC) threshold or TCC configurable offset, etc. In addition, the thermal management parameter may also include device thickness (Z-height), etc.

In some embodiments, by executing a performance test procedure on each tested electronic device, the actual performance test score of each tested electronic device is obtained based on the device design parameter and the actual target design parameter of each tested electronic device. The performance test procedure is configured to measure the performance of the processor (e.g., CPU) under different load conditions. Each tested electronic device may execute the performance test procedure by running performance benchmark tools. The performance benchmark tools may be, for example, Cinebench R23 (CR23), GeekBench, SiSoftware Sandra, or PassMark, etc., which is not limited in the disclosure. When the processor in each tested electronic device executes the performance test procedure, the performance benchmark tool may output the actual performance test score of the processor in each tested electronic device. For example, the actual performance test score may be the CR23 Multi-Threaded (MT) score. In other words, with all hardware configurations and parameter settings of each tested electronic device determined, by actually executing a performance test procedure using performance benchmark tools on these tested electronic devices, corresponding actual performance test scores can be obtained. The actual performance test scores of these tested electronic devices may be collected and recorded. Through file reading or receiving user input, the processor 150 may obtain the actual performance test scores of these tested electronic devices. The processor 150 may pair these actual performance test scores of the tested electronic devices with corresponding device design parameters to generate a training dataset.

In some embodiments, the actual target design parameter is the device design parameter that the developer wants to find, which is also the target variable for the machine learning model. In some embodiments, the actual target design parameter may include a Power Limit 2 (PL2).

At step S220, the processor 150 may train a machine learning model based on the training dataset. In some embodiments, the machine learning model may include a supervised machine learning model applying a supervised machine learning algorithm. The supervised machine learning algorithm may be a regression analysis algorithm, eXtreme Gradient Boosting (XGboost) algorithm, Bootstrap aggregating (Bagged) algorithm, neural network algorithm, Random Forest algorithm, Elastic Net algorithm, least absolute shrinkage and selection operator (LASSO) algorithm, k-nearest neighbor classification (KNN) algorithm, support vector regression algorithm or Ensemble learning algorithm, etc., which this invention does not limit.

In the disclosed embodiments, the processor 150 may utilize the training dataset to conduct machine learning, analyze and create an association model between device design parameters and processor performance. Specifically, the processor 150 may establish a machine learning model based on the device design information of many previously tested electronic devices. The trained machine learning model may be recorded in the storage device 130. In other words, the machine learning model is a prediction model created by the processor 150 based on machine learning using the training dataset to predict the optimal settings for one or more target design parameter(s). The optimal configuration values of the one or more target design parameters can enable the processor's performance to exceed the testing standards.

In some embodiments, the processor 150 may select multiple important feature variables based on feature selection algorithms in feature engineering. The processor 150 may train the machine learning model according to these important feature variables and target variables in the training dataset.

At step S230, the processor 150 may receive a device design parameter of an electronic device to be tested. In some embodiments, the processor 150 may receive the device design parameter of the electronic device to be tested via the input device 110. In other words, when the developer conducts device development for the electronic device to be tested, the developer may provide the device design parameter of the electronic device to be tested to the trained machine learning model.

At step S240, the processor 150 may predict a predicted target design parameter of the electronic device to be tested by utilizing the trained machine learning model according to the device design parameter of the electronic device to be tested. In some embodiments, the predicted target design parameter may include a short-term maximum power limit (PL2). Specifically, the processor 150 may use the trained machine learning model to conduct model inference. Through the inference of the machine learning model, the processor 150 maps these device design parameters of the electronic device to be tested to the expected predicted target design parameter (for example, short-term maximum power limit), thereby helping developers quickly make appropriate design adjustments to achieve the required performance requirements.

At step S250, the processor 150 may perform an operation according to the predicted target design parameter. In some embodiments, the processor 150 may display and record the predicted target design parameter of the electronic device to be tested. In this way, by observing the user operation interface displayed on the display device 120, the developer may learn the setting value of the predicted target design parameter of the electronic device to be tested. Furthermore, in some embodiments, the processor 150 may also record multiple target setting values of the predicted target design parameter under different design solutions. For example, in the first design solution, a certain device design parameter has a first setting value, while in the second design solution, that device design parameter has a second setting value. Therefore, the processor 150 may decide which design solution to use by analyzing these target setting values of the predicted target design parameter.

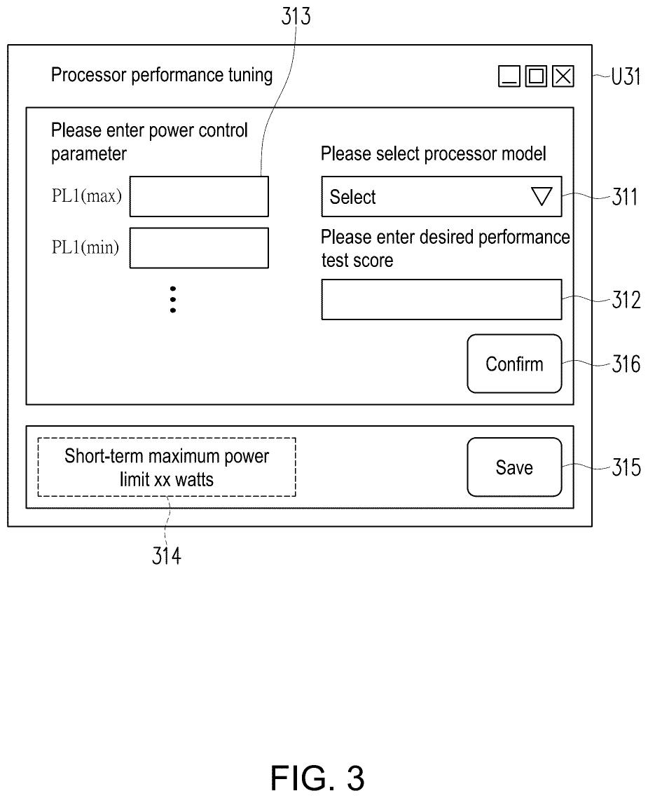

For example, referring to FIG. 3, which is a schematic diagram of a user operation interface for tuning processor performance according to an embodiment of the disclosure. The processor 150 may display the user operation interface U31 via the display device 120. The developer may input the device design parameters and desired performance test scores of the electronic device to be tested by utilizing the user operation interface U31, and observe the user operation interface U31 to learn the predicted target design parameter predicted by the machine learning model.

In such example, the developer may select the processor model in the input field 311, and the processor 150 may obtain the processor specification parameters according to the processor model selected by the developer. The developer may input the desired performance test score in the input field 312. The developer may input the power control parameter in the input field 313. After completing the setting and input of these device design parameters, the developer may click the user interface option 316 to activate the machine learning model for inference. Subsequently, the predicted target design parameter 314 predicted by the machine learning model may be displayed in the user operation interface U31, and the developer may click the user interface option 315 to store the predicted target design parameter 314.

Based on the preceding content, it may be known that in the embodiments of the disclosure, the target variable of the machine learning model may include or may not include the performance test score. The following will list embodiments to illustrate separately.

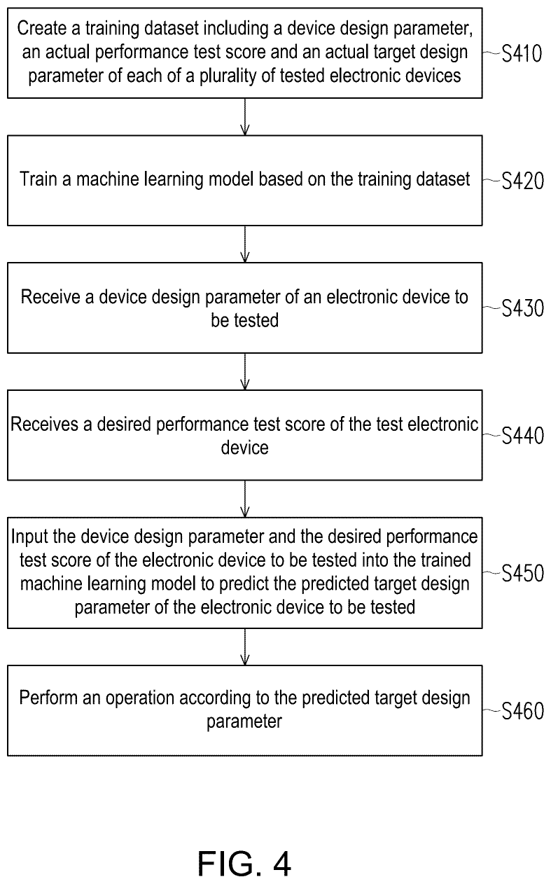

FIG. 4 is a flowchart of a processor performance tuning method according to an embodiment of the disclosure, and the method process of FIG. 4 may be implemented by various components of the electronic device 100 in FIG. 1. Referring to both FIG. 1 and FIG. 4, the following will explain the steps of the processor performance tuning method in this embodiment in conjunction with various components of the electronic device 100 in FIG. 1.

At step S410, the processor 150 creates a training dataset. This training dataset may include a device design parameter, an actual performance test score, and an actual target design parameter for each of multiple tested electronic devices. For example, Table 1 is part of the training data in a training dataset regarding a certain tested electronic device.

TABLE 1

| number | number | | increase | | | | | |
|---|---|---|---|---|---|---|---|---|
| of | of | cache | clock | PL1 | PL1 | | CR23 | |
| cores | threads | capacity | frequency | (max) | (min) | Tcc | score | PL2 |
| 6 | 22 | 24 | 5.1 | 65 | 30 | 110 | 15710 | 48 |
| 6 | 22 | 24 | 5.1 | 65 | 30 | 110 | 16840 | 56 |
| 6 | 22 | 24 | 5.1 | 65 | 30 | 110 | 18192 | 72 |

Moreover, Table 2 is part of the training data in the same training dataset regarding another tested electronic device.

TABLE 2

| number | number | | increase | | | | | |
|---|---|---|---|---|---|---|---|---|
| of | of | cache | clock | PL1 | PL1 | | CR23 | |
| cores | threads | capacity | frequency | (max) | (min) | Tcc | score | PL2 |
| 6 | 22 | 24 | 4.8 | 65 | 45 | 110 | 15331 | 52 |
| 6 | 22 | 24 | 4.8 | 65 | 45 | 110 | 14908 | 60 |
| 6 | 22 | 24 | 4.8 | 65 | 45 | 110 | 14818 | 76 |

In the examples of Table 1 and Table 2, the actual target design parameter for each tested electronic device may be PL2.

At step S420, the processor 150 may train a machine learning model based on the training dataset. At step S430, the processor 150 may receive a device design parameter of a test electronic device. Detailed implementation details may be referred to in the previously described embodiment and will not be repeated here.

At step S440, the processor 150 receives a desired performance test score of the test electronic device. It should be noted that the desired performance test score may be a value set by the developer. At step S460, the processor 150 may input the device design parameter and the desired performance test score of the test electronic device into the trained machine learning model to predict a predicted target design parameter of the test electronic device. At step S470, the processor 150 may perform an operation according to the predicted target design parameter.

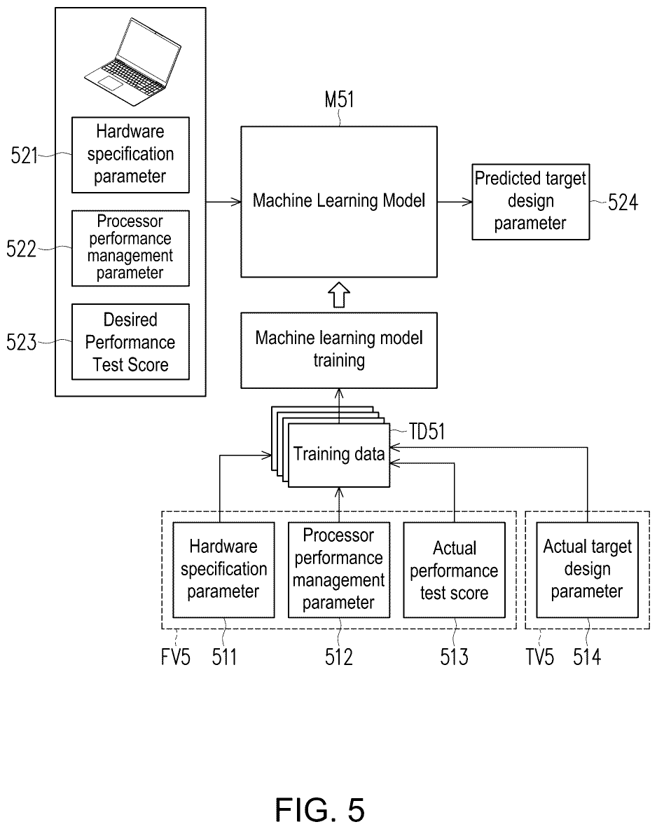

Referring to FIG. 5, which is a schematic diagram of a processor performance tuning method according to an implementation of the disclosure. The processor 150 may collect hardware specification parameters 511, processor performance management parameters 512, actual performance test scores 513, and actual target design parameters 514 from multiple tested electronic devices, and establish a training dataset TD51 based on these. This training dataset TD51 may include feature variables FV5 and target variables TV5. In this example, the feature variables FV5 may include the hardware specification parameters 511, the processor performance management parameters 512, and the actual performance test scores 513, while the target variables TV5 may include the actual target design parameters 514. The processor 150 may conduct machine learning model training based on the training dataset TD51, thereby creating a machine learning model M51. Subsequently, the processor 150 may input a hardware specification parameter 521 and a processor performance management parameter 522 of the test electronic device provided by the developer, as well as the desired performance test score 513, into the machine learning model M51. The machine learning model M51 may correspondingly output the setting value of the predicted target design parameter 524.

For example, the trained machine learning model may map the hardware specification parameters, processor performance management parameters, and desired performance test score input by the developer to a short-term maximum power consumption limit (PL2), and this short-term maximum power consumption limit may enable the processor performance of the test electronic device to achieve the desired performance test score. In other words, when the developer provides hardware specification parameters, processor performance management parameters, and a predetermined desired performance test score to be achieved, the machine learning model may infer the ideal setting value for the short-term maximum power consumption limit.

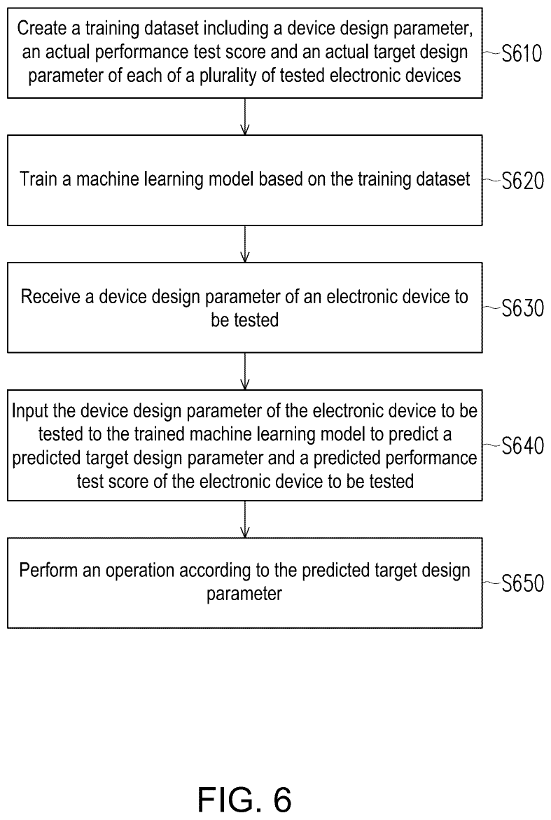

FIG. 6 is a flowchart of a processor performance tuning method according to an implementation of the disclosure, and the method process of FIG. 6 may be implemented by various components of the electronic device 100 in FIG. 1. Please refer to both FIG. 1 and FIG. 6. The following will explain the steps of the processor performance tuning method in this implementation in conjunction with the various components of the electronic device 100 in FIG. 1.

At step S610, the processor 150 may create a training dataset. This training dataset may include a device design parameter, an actual performance test score, and an actual target design parameter for each of multiple tested electronic devices. At step S620, the processor 150 may train a machine learning model based on the training dataset. At step S630, the processor 150 may receive a device design parameter of a test electronic device.

At step S640, the processor 150 may input the device design parameter of the test electronic device into the trained machine learning model to predict a predicted target design parameter and a predicted performance test score for the test electronic device. At step S650, the processor 150 may perform an operation according to the predicted target design parameter.

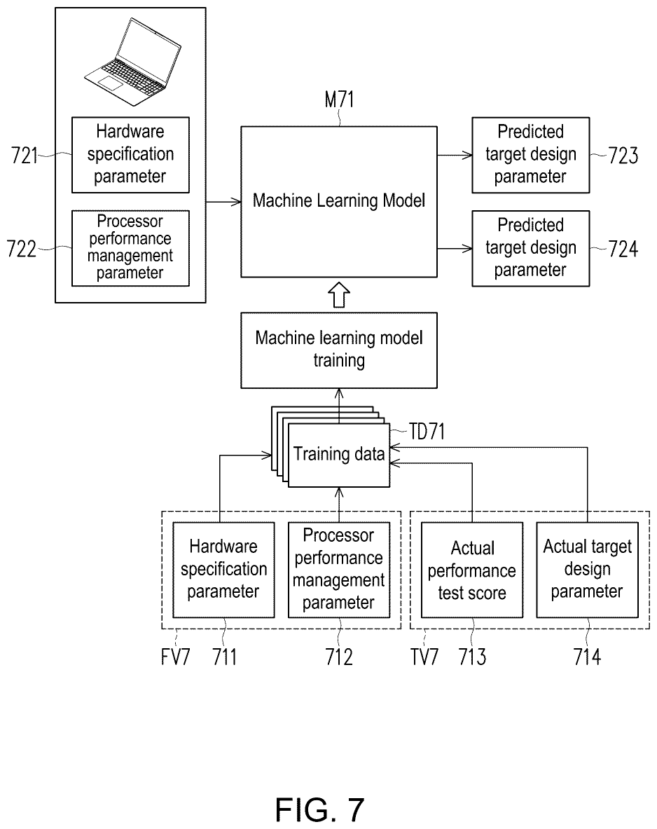

Referring to FIG. 7, which is a schematic diagram of a processor performance tuning method according to an implementation of the disclosure. The processor 150 may collect hardware specification parameters 711, processor performance management parameters 712, actual performance test scores 713, and actual target design parameters 714 from multiple tested electronic devices, and create a training dataset TD71 based on these. This training dataset TD71 may include feature variables FV7 and target variables TV7. In this example, the feature variables FV7 may include hardware specification parameters 711 and processor performance management parameters 712, while the target variables TV7 may include actual performance test scores 713 and actual target design parameters 714. The processor 150 may conduct machine learning model training based on the training dataset TD71, thereby creating a machine learning model M71. Subsequently, the processor 150 may input the hardware specification parameter 721 and the processor performance management parameter 722 of the test electronic device provided by the developer into the machine learning model M71. The machine learning model M71 may correspondingly output the setting value of the predicted target design parameter 724 and the value of the predicted performance test score 723.

For example, the trained machine learning model may map the hardware specification parameter and processor performance management parameter input by the developer to a short-term maximum power consumption limit and a predicted performance test score, where this short-term maximum power consumption limit may enable the processor performance of the test electronic device to achieve the predicted performance test score. In other words, when the developer provides hardware specification parameters and processor performance management parameters, the machine learning model may infer the predicted performance test score that can be achieved under this design solution and the corresponding short-term maximum power consumption limit (PL2).

In summary, in the embodiments of the disclosure, a training dataset including device design parameters, actual performance test scores, and actual target design parameters from multiple tested electronic devices may be utilized to train a machine learning model. Subsequently, the trained machine learning model may predict a predicted target design parameter for the electronic device to be test based on the device design parameters of the electronic device to be test, to perform an operation based on the predicted target design parameter. Based on this, the optimal parameter settings that can meet the required processor performance may be determined more efficiently, thereby shortening the product development and testing timeline.

In addition, when specification changes occur during the device design stage, the trained machine learning model may be utilized to predict the predicted target design parameters that conform to the existing design solution. Based on this, repetitive parameter adjustments and performance tests may be avoided, thereby shortening the device development timeline. Since the machine learning model may infer parameter settings under various design solutions based on past design data, it may conveniently allow developers to evaluate the advantages, disadvantages, and feasibility of various design solutions.

Although the disclosure has been disclosed in the implementation as above, it is not intended to limit the disclosure. Any person skilled in the art may make some modifications and refinements without departing from the spirit and scope of the disclosure. Therefore, the scope of protection of the disclosure should be defined by the appended claims.

What is claimed is:

1. A processor performance tuning method, comprising:
creating a training dataset, wherein the training dataset comprises a device design parameter, an actual performance test score and an actual target design parameter of each of a plurality of tested electronic devices;
training a machine learning model based on the training dataset;
receiving a device design parameter of an electronic device to be tested;
predicting a predicted target design parameter of the electronic device to be tested by utilizing the trained machine learning model according to the device design parameter of the electronic device to be tested; and
performing an operation according to the predicted target design parameter.

2. The processor performance tuning method as claimed in claim 1, further comprising:
by executing a performance test procedure through each of the plurality of tested electronic devices, obtaining the actual performance test score of each of the plurality of tested electronic devices based on the device design parameter and the actual target design parameter of each of the plurality of tested electronic devices.

3. The processor performance tuning method as claimed in claim 1, wherein the device design parameter comprises at least one of a hardware specification parameter and a processor performance management parameter.

4. The processor performance tuning method as claimed in claim 3, wherein the hardware specification parameter comprises at least one of a processor specification parameter and a heat dissipation specification parameter.

5. The processor performance tuning method as claimed in claim 3, wherein the processor performance management parameter comprises at least one of a power control parameter and a thermal management parameter.

6. The processor performance tuning method as claimed in claim 1, wherein the step of executing the operation according to the predicted target design parameter comprises:
displaying and recording the predicted target design parameter of the electronic device to be tested.

7. The processor performance tuning method as claimed in claim 1, wherein the actual target design parameter comprises a short-term maximum power limit, and the predicted target design parameter comprises a short-term maximum power limit.

8. The processor performance tuning method as claimed in claim 1, further comprising:
receiving a desired performance test score of the electronic device to be tested,
wherein the step of predicting the predicted target design parameter of the electronic device to be tested by utilizing the trained machine learning model according to the device design parameter of the electronic device to be tested comprises:
inputting the device design parameter and the desired performance test score of the electronic device to be tested into the trained machine learning model to predict the predicted target design parameter of the electronic device to be tested.

9. The processor performance tuning method as claimed in claim 1, wherein the step of predicting the predicted target design parameter of the electronic device to be tested by utilizing the trained machine learning model according to the device design parameter of the electronic device to be tested comprises:
inputting the device design parameter of the electronic device to be tested into the trained machine learning model to predict the predicted target design parameter and a predicted performance test score of the electronic device to be tested.

10. An electronic device, comprising:
a storage device; and
at least one processor, coupled to the storage device, configured to:
create a training dataset, wherein the training dataset comprises a device design parameter, an actual performance test score and an actual target design parameter of each of a plurality of tested electronic devices;
train a machine learning model based on the training dataset;
receive a device design parameter of an electronic device to be tested;
predict a predicted target design parameter of the electronic device to be tested by utilizing the trained machine learning model according to the device design parameter of the electronic device to be tested; and
perform an operation according to the predicted target design parameter.
